(19) United States
(12) Patent Application Publication
(10) Pub. No.: US 2002/0029198 A1
(43) Pub. Date: Mar. 7, 2002

(54) Flexible information and business logic software engine

(76) Inventor: Stuart Hoffman, Arlington, VA (US)

Correspondence Address: Robert Platt bell, Registered Patent Attorney, 8033 Washington Road, Atexandria, VA, 22308, US

(21) Appl. No.: 09/895,182

(22) Filed: Jul. 2, 2001

Related U.S. Application Data
(62) Division of application No. 09/311,262, filed on May 14, 1999.
(60) Provisional application No. 60/085,737, filed on May 15, 1998.

(51) Int. Cl. G06F 17/60

(52) U.S. Cl. 705/40

(57) ABSTRACT

A flexible billing system and method of managing the billing needs of both customers and users. Billing events such as telephone calls are logged and stored by a computer. These events are then accessed by the billing system and associated with customers. Customers are billed based on the pricing rule they are associated with. Bills may then be created according to the bill format the customer is associated with and the customers is then invoiced.

### CROSS-REFERENCE TO RELATED APPLICATIONS

The present application claims priority from Provisional U.S. Patent Application Ser. No. 60/085,737, filed May 15, 1998 and incorporated herein by reference.

The present application is a Divisional Application of U.S. patent application Ser. No. 09/311,262, filed May 14, 1999 and incorporated herein by reference.

### FIELD OF THE INVENTION

This invention relates to billing systems. In particular to flexible billing systems with the ability to meet individual customer needs.

### BACKGROUND OF THE INVENTION

The act of billing customers and clients has always been a routine and necessary task for every type of business. Routine tasks lend themselves to automation.

However, until the present invention, having to automate large numbers of customers destroyed the chance for a flexible system. Through automation every customer receives the same bill format. Every customer also has the same billing rate formula, for example in the communications industry, 10 cents a minute for phone calls between 9 PM and 9 AM.

With respect to businesses who are doing the billing, their is current systems are completely integrated such that they will only retain the data in one format. Those who bill also lack the ability to arrange different billing rate formulas for individual customers as well as different bill formats to meet each individual customer needs. Also lacking is the ability to create a new billing rate formula instantaneously to immediately meet the needs of each individual customer.

These problems present a need for billing flexibility. All customers do not have the same needs. For example, some may wish 10 cents a minute, some may prefer 15 cents a minute for the first 10 minutes and 5 cents every minute thereafter.

Businesses wish to keep their current data in the same format they are presently using in order to avoid costly time consuming data conversions. Data conversion allows all their systems, not just the billing system, to make use of the data. Businesses also have a need to customize the format of the bills and tailor the billing calculations to customer needs.

### SUMMARY OF THE INVENTION

The present invention comprises a flexible billing system. A brief example of a possible embodiment of the billing system follows. Billing events such as telephone calls are logged and stored by a computer. These events are then accessed by the billing system and associated with customers. Bills are then created and customers are invoiced. This billing system is uniquely flexible, as the following summary demonstrates.

Business owners are able to create new services at any time. For example, a telephone company may wish to offer internet access and therefore create a new service which requires a different billing procedure. This billing system is able to create a new service, without having to re-write the program, at any time.

Different pricing rules may apply to each service. For example, a customer may be billed 10 cents a minute for phone calls. For the internet access there may be an additional $20 a month. Each service, telephone and internet access have separate pricing rules. Pricing rules may be created at any time. Individual customers may also have unique pricing rules. One customer may pay 10 cents a minute while another pays $10 a month and 8 cents a minute. This allows the company doing the billing to meet the needs of each individual customer by creating unique pricing rules for each customer.

Customers are able to receive unique bill statements. This billing system allows invoices to be unique for each customer. Customers may wish to have the invoice information displayed in a specific format. Each customer may have a different format. Through the bill painter, the use of a GUI (graphical user interface) allows a customers invoice format to be created, modified, and changed, at any time.

Customers may sign up for any service at any time. Groups may be created which consist of multiple customers. One customer may be VDT Inc., which may comprise five customers who are all employees of VDT Inc. Groups may be created, modified, and changed at any time.

Those who use the billing system will be able to keep their data in their current format. Data repositories, such as flat files, relational databases, or any other data repository may be accessed by the billing system. There is no need for time consuming and costly conversion of current data to a new format in order to use the billing system.

Invoices may then be sent out to the appropriate customers.

### BRIEF DESCRIPTION OF THE DRAWINGS

FIG. 1 is a schematic representation illustrating one embodiment of people interacting with the billing system.

FIG. 2 is a schematic representation illustrating the overall billing system.

FIG. 3 is a table illustrating class definitions.

FIG. 4 is a table illustrating classes and their data elements.

FIG. 5 is a table illustrating saved queries.

FIG. 6 is a table illustrating business rules.

FIG. 7 is a table illustrating class constraints.

FIG. 8 is a table illustrating object identifiers.

FIG. 9 is a table illustrating the customer account class.

FIG. 10 is a table illustrating a class containing customer calls.

FIG. 11 is a table illustrating the bill class.

FIG. 12 is a table illustrating the bill period class.

FIG. 13 is a table illustrating a movie rate class.

FIG. 14 is a diagram illustrating the interaction between components of the billing system.

FIG. 15 is a flow chart illustrating the creation and definition of services.

FIG. 16 is a flow chart illustrating the creation of pricing rules.

FIG. 17 is a flow chart illustrating the creation of bill formats and reports.

FIG. 18 is a flow chart illustrating the creation of new customers.

FIG. 19 is a flow chart illustrating the creation of customer groups.

FIG. 20 is a flow chart illustrating the billing events.

FIG. 21 is a screen capture illustrating the billing system 4 sign in window.

FIG. 22 is a screen capture illustrating the name and address portion of signing up new customers.

FIG. 23 is a screen capture illustrating the billing options portion of signing up new customers.

FIG. 24 is a screen capture illustrating the billing portion of signing up new customers.

FIG. 25 is a screen capture illustrating the display of groups which are stored in the CustomerAccount class.

FIG. 26 is a screen capture illustrating the various billing periods stored in the bill period class.

FIG. 27 is a screen capture illustrating a representative bill format stored in the business rules table.

FIG. 28 is a screen capture illustrating an embodiment of the bill painter.

FIG. 29 is a screen capture illustrating the step by step display of a calculation for a pricing formula.

FIG. 30 is a screen capture illustrating the available services associated with a particular class.

FIG. 31 is a screen capture illustrating a newly created class movie rates.

FIG. 32 is a screen capture illustrating field definitions which make up the data dictionary.

FIG. 33 is a screen capture illustrating queries stored in the saved queries table.

FIG. 34 is a screen capture illustrating window help topics.

FIG. 35 is a screen capture illustrating multiple windows may be displayed simultaneously.

### DETAILED DESCRIPTION OF THE INVENTION

Currently, the best implementation of this billing system has an object oriented data model. A relational database holds the data. Other databases may be used, such as object oriented and this system is not limited to the current implementation.

This billing system takes in events, such as phone call records, and creates bills as well as reports. Events are read into the system. Multiple services may be created, for instance: long distance phone service, internet usage, radio advertising, etc.

Customers are added to the system and are associated with services and the events related to each service. Customers may also be a group of customers, for example a company containing multiple employees. Pricing rules are then created and associated with customers to determine how much each customer needs to pay. Pricing rules may be altered, and may be different for each customer.

Bills and reports are then generated by the system. Bills may be formatted to meet customer needs. The system allows users to create unique reports and bill formats using a GUI (graphical user interface). The following is a detailed description of the invention with reference to the figures.

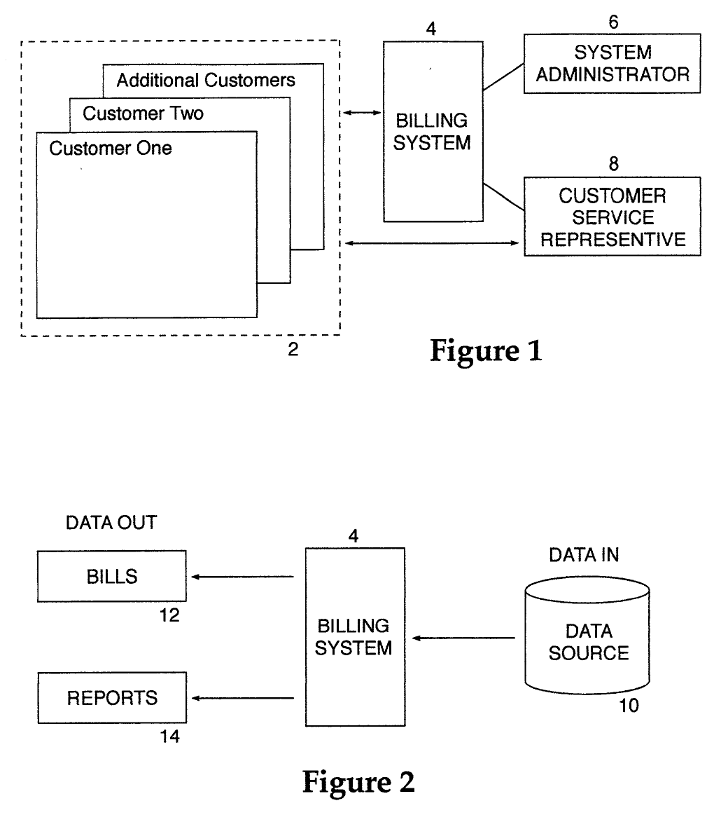

FIG. 1 is a schematic representation showing the billing system 4. Customers 2 may interact with billing system 4 in multiple ways. For example, one of the customers 2 may receive a customized bill. Bills and other inquiries may be received by, but are not limited to, mail, e-mail, and web pages. Customers 2 may also interact with billing system 4 through customer service representative 8. Billing system 4 may interact with as many customers as required. Customer service representative 8 may make changes or additions, such as creating a new billing format, change customer 2 billing rules, add or subtract services, and generate reports. Customer service representative 8 has limited authority to make changes or additions. System administrator 6 manages the billing system and may interact with billing system 4 to define services, create pricing rules, create bill/report formats, sign up customers, place customers in customer groups, create billing events, and all other system tasks which a customer service representative 8 does not have the authority to do.

FIG. 2 is a schematic of the overall billing system 4. Data, such as telephone logs, may be read into the billing system and bills and reports are sent out. Billing system 4 may read in billing data from any number of data sources 10 such as, but not limited to, flat files, databases, and other mediums. Billing system 4 may also send out unique and distinct bills 12 to customers 2. Bills 12 may be in customized bill formats with different pricing rules for different customers 2 with the same service. Reports 14 may be created at any time for customers 2, system administrators 6, and customer service representatives 8. Each report 14 may be customized with unique queries created dynamically during the billing systems 4 operation.

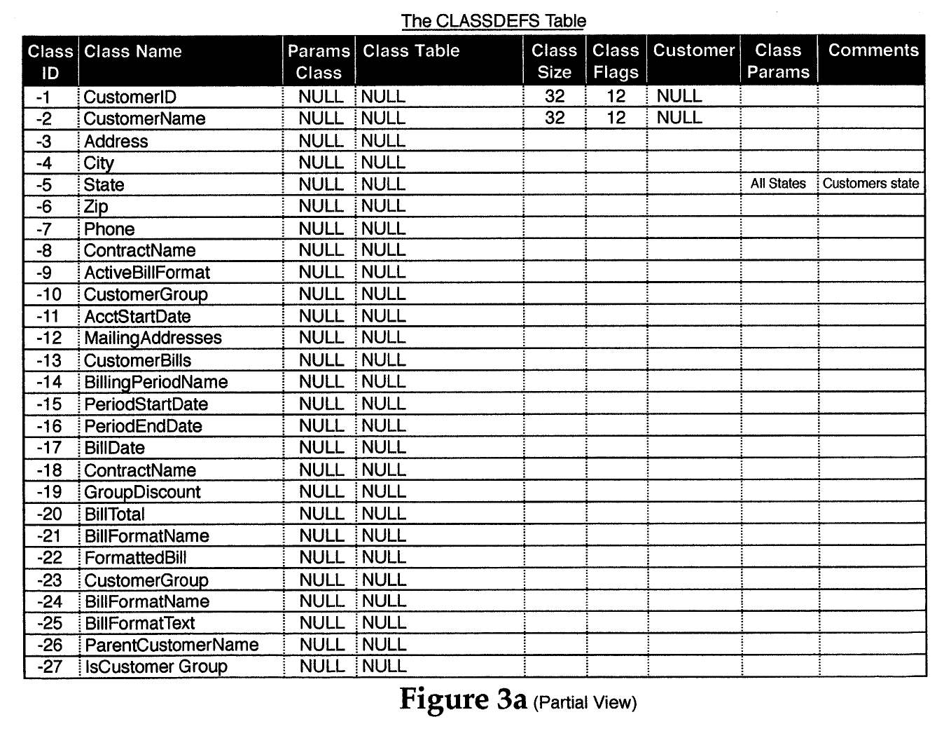

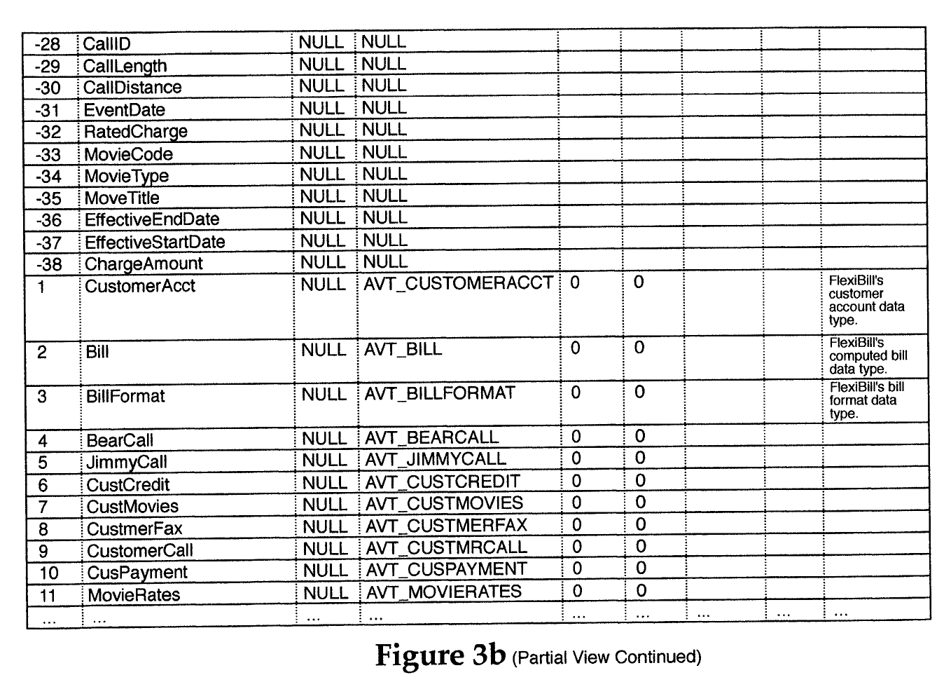

FIGS. 3-8 illustrate tables used by the billing system 4. These system tables are present in every billing system 4.

FIG. 3 displays a system table containing class definitions, CLASSDEFS table. Each class has an ID associated with it. Negative ID numbers denote a data element. Positive ID numbers denote a class definition.

An example of a data element is “CustomerID” in column two row one, entitled “class name”. CustomerID has a negative value which denotes it as a data element, shown in column one entitled “Class ID”. Column five, entitled “Class Size” denotes the size of the data element in characters or bytes. Column six, entitled “Class Flags” is a system attribute for the classes and elements.

An example of a second data element is “State” in column two row five, entitled “class name”. “State” has a negative value which denotes it as a data element, shown in column one entitled “Class ID”. Column 8, entitled “Class Params”, denotes parameters for the element or class. In the case of data element “state”, the “Class Params” indicates the value may be any 50 states. Column 9, entitled “Comments”, may be non-functional and contain developer comments.

An example of a class definition is “CustomerAccount” in column two. CustomerAccount has a positive ID of 1, located in column one, which denotes it as a class definition. An example of a second class definition is “Bill” in column two. Bill has a positive ID of 2, located in column one, which denotes it as a class definition.

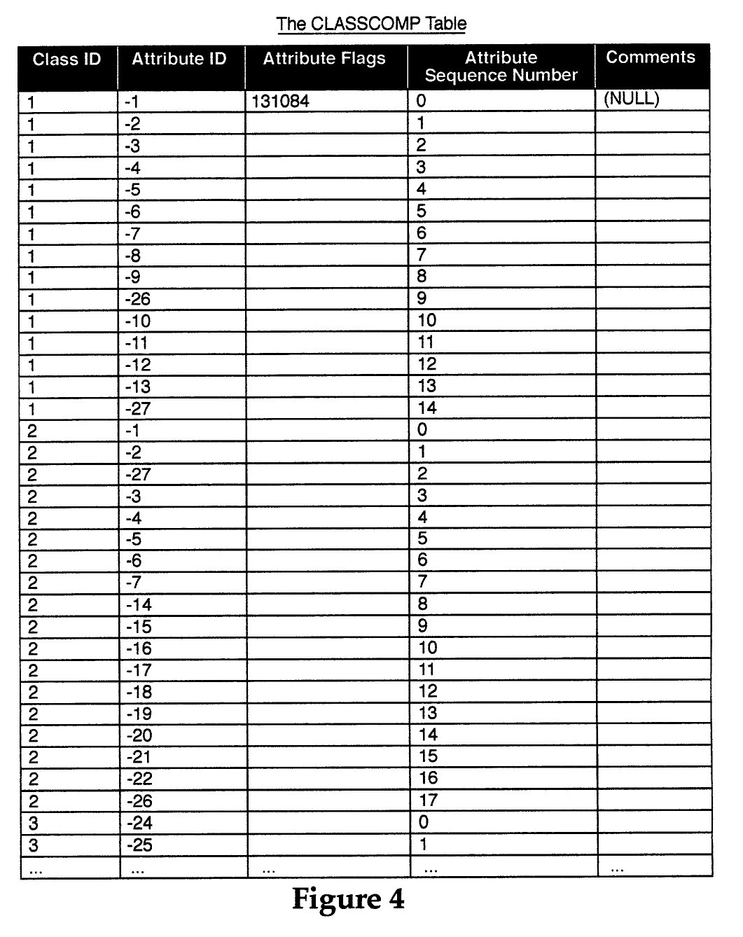

FIG. 4 displays a system table defining classes and their data elements, CLASSCOMP table. Numbers listed in column one entitled “Class ID” and numbers listed in column two entitled “Attribute ID” correspond to the numbers listed in column one entitled “Class ID” in FIG. 3.

Column three entitled “Attribute Flags” denotes how the data element in the class corresponding to the Class ID may be used, and is represented by a hexadecimal number. Attribute flags allow data elements to have different attributes depending on which class their in. An example of an attribute is whether or not to display the data element on the screen. Column four entitled “Attribute Sequence Number” denotes the order of the data elements in the class, starting the count with 0.

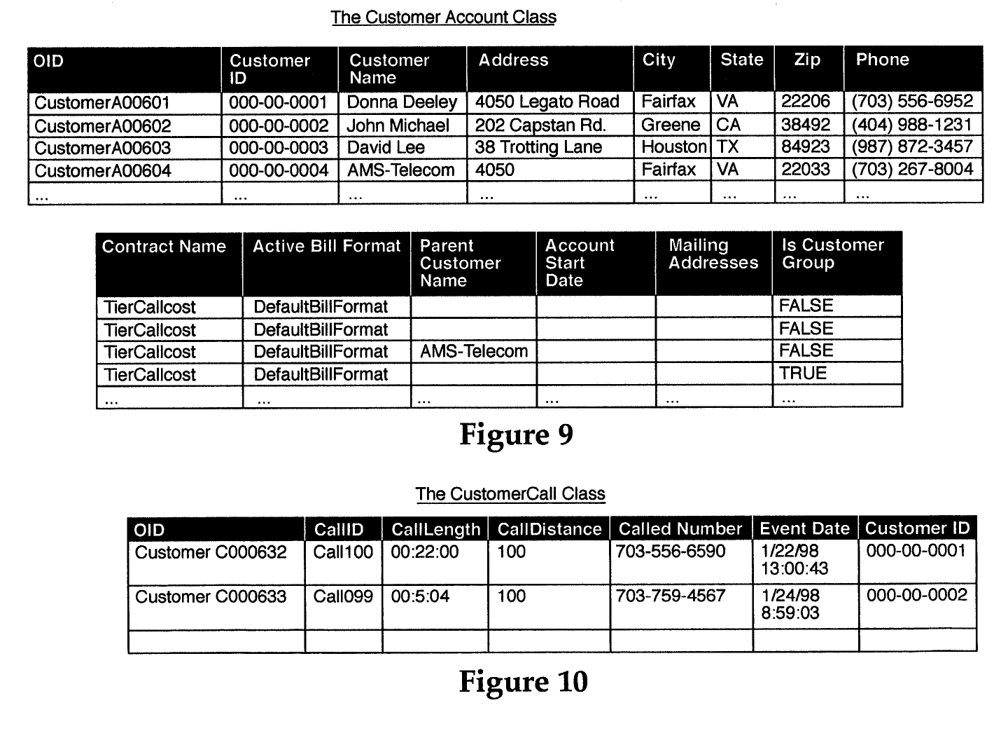

As an illustrative example, in FIG. 3 the CustomerAccount class has a corresponding Class ID of 1. Therefore in FIG. 4 all of the rows with a Class ID of 1 define the CustomerAccount table shown in FIG. 9. Row one of FIG. 4 has a Class ID of 1 denoting this row makes up part of the CustomerAccount table. Row one, column two, shows an Attribute ID of −1 corresponding to column one in FIG. 3, entitled Class ID, which denotes −1 is the data element CustomerID. Row one, column three, shows an attribute flag shown in hexadecimal notation which denotes an attribute of the data element CustomerID. Column four shows the Attribute Sequence Number is 0, therefore the first data element in the CustomerAccount table of FIG. 9 is CustomerID.

Row two of FIG. 4 has a Class ID of 1 denoting this row makes up part of the CustomerAccount table. Row two, column two, shows an Attribute ID of −2 corresponding to column one, entitled Class ID in FIG. 3 which denotes −2 is the data element CustomerName. Following row one across, in FIG. 4, shows the Attribute Sequence Number in column four, is 1. The third data element in the CustomerAccount table of FIG. 9 is therefore CustomerName.

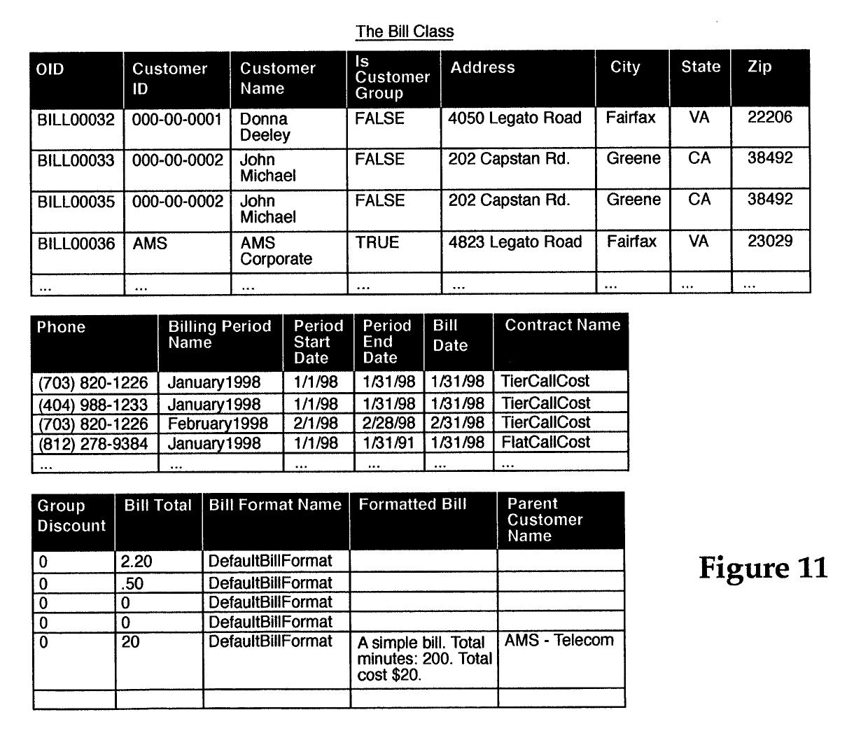

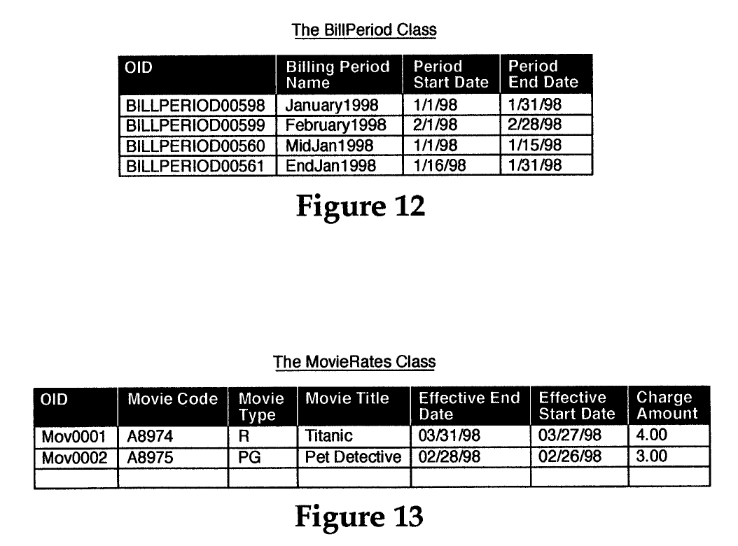

The same logic used for rows one and two may be used throughout the system table defining classes of FIG. 4. Class IDs corresponding to 2 define the Bill table shown in FIG. 11. Class IDs corresponding to 3 define the BillFormat table shown in FIG. 10. Other classes include the BillPeriod class shown in FIG. 12, and the CustomerGrps class shown in FIG. 13.

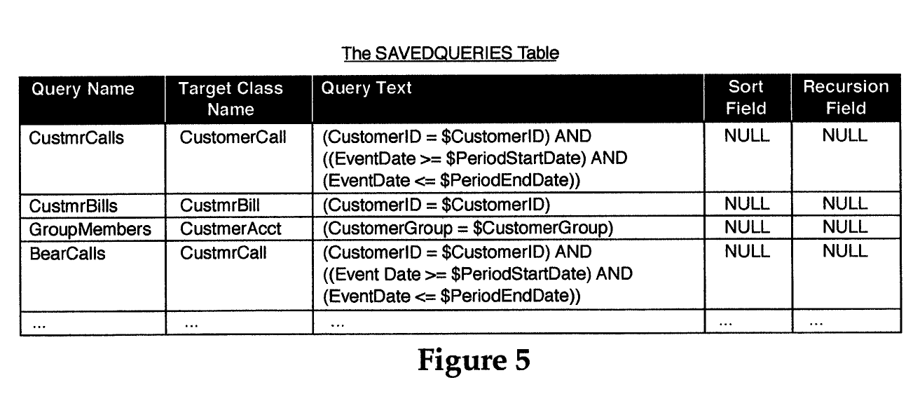

FIG. 5 displays a system table consisting of queries, SAVEDQUERIES table. Queries are automatically generated by the billing system 4, and may also be created by system administrators 6. Queries which are automatically generated are default queries. For example, when a new service is created, by the billing system administrator 6 or customer service representative 4, a query such as retrieving all customer calls within a certain date. Default queries may be changed. Queries may be put into reports or used in computations of bills.

Column one, entitled “Query Name” denotes the name of the saved query which will displayed to the billing system administrator 6, or customer service representative 8. Column two, entitled “Target Class Name” denotes the class the query will be performed on. Column three, entitled “Query Text” contains the query language for the query.

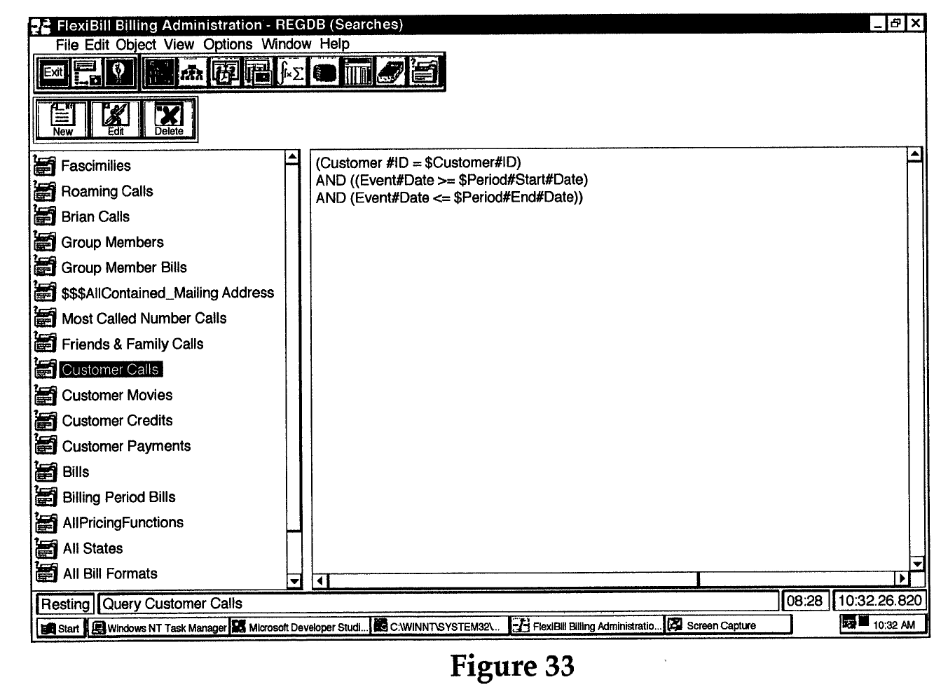

For example, row one contains a query named CustomerCalls which may be run by the billing system administrator 6, or customer service representative 8. CustomerCalls query will be run on the CustomerCall class table, and the query to be performed may be listed in the third column. This particular query will return all calls which a particular customer has made between a given starting and ending date. Screen capture FIG. 33 shows a list of queries. In FIG. 33, Customer Calls is highlighted and reflects the data stored in the SavedQueries table in FIG. 5.

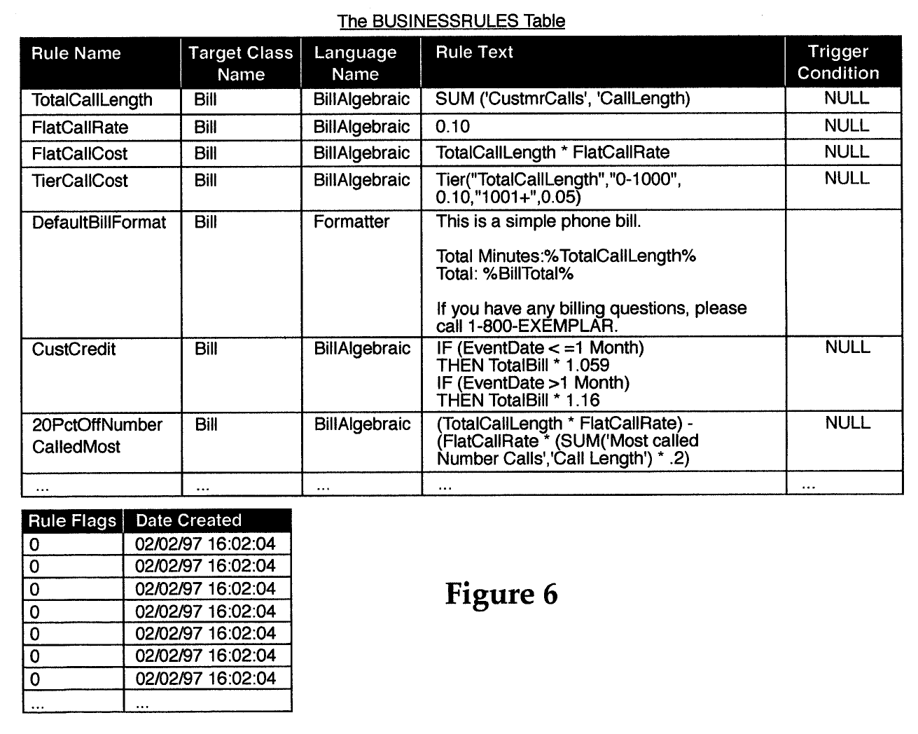

FIG. 6 displays the BUSINESSRULES system table. Column one, entitled “Rule Name” denotes the name of the saved rule which will be displayed to the billing system administrator 6, or customer service representative 8. Column two denotes which class the rule applies to. Column three denotes the “Language Name”. Language name may be either bill algebraic or formatter.

Bill algebraic notation may be used to form pricing rules. For example, row one contains a pricing rule named TotalCallLength which applies to the class Bill. The rule text specifies that the rule is to return the sum of the lengths of all of a particular customers calls.

Formatter notation may be used for bill formats. For example, row five contains a bill format named DefaultBillFormat which applies to the class Bill. Formatter notation defines how the bill will look and which fields will be used in calculation of the bill.

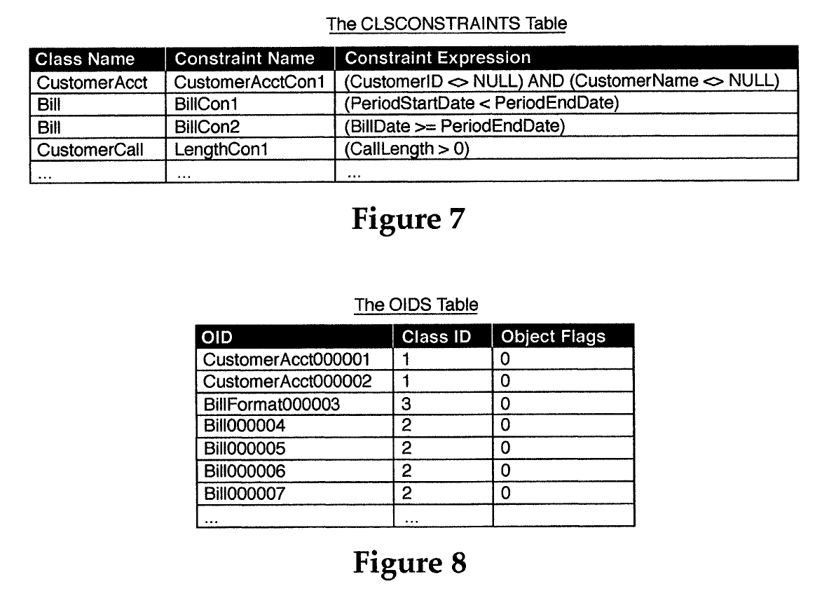

FIG. 7 displays a system table consisting of constraints, CLSCONSTRAINTS table. Constraints are used to limit data fields. Column one, entitled “Class Name” denotes the class which has a restraint applied to it. Column two, entitled “Constraint Name” denotes the name of the constraint. Column three denotes the constraint expression. For example, row one has a constraint name CustomerAccountConl applied to the CustomerAccount class. The constraint expression “(CustomerID<>NULL) AND (CustomerName<>NULL)” will not allow a customer account to be created unless a customer name has been given and a customer ID created.

FIG. 8 displays a system table consisting of OID numbers, the OIDS table. OID number may comprise an object identifier. Each data object has a unique identifier.

FIGS. 9-13 represent classes which may be created during the use of the billing system 4. These are not the only classes which may be used, but are described here as an example. Multiple classes may be created and are created by the billing system 4 as it is in use and as they are needed. The types of classes created depend on the needs and requirements of the entity using the billing system. For example, a company keeping track of movie rental bills may have a class entitled CustMovies, while a company keeping track of faxes sent by customers may have a class entitled CustmerFax. These classes will contain the relevant information which may be required by the company performing the billing.

FIG. 9 illustrates the Customer Account class table. Each row contains information on a customer. For example, row one shows Donna Deeley has a customer ID of 111-11-111, lives at 4050 Legato 10 Road, Fairfax, Va., 22206, and may be reached at (703) 556-6950. The unique object identifier is shown in column one and in the case of the first row containing Stuart Hoffman, the OID is “CustomerA00601”. Mrs. Deeley's contract name may be stored as TierCallCost. TierCallCost may comprise the pricing rule found in the BUSINESSRULES system table, FIG. 6.

Mrs. Deeley's bill format name may be stored as DefaultBillFormat. DefaultBillFormat may be found in the BUSINESSRULES system table FIG. 6, which defines how Mrs. Deeley's bill will look.

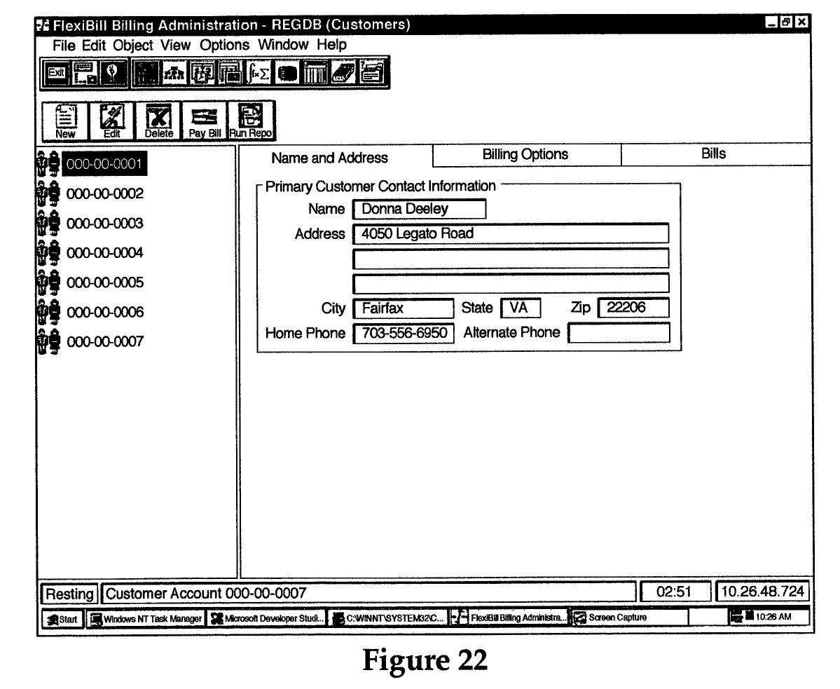

This sample data reflects the data found in screen capture FIGS. 22, 23, 24.

FIG. 10 illustrates the CustomerCall class table. CustomerCall is an example of a newly created service. The data elements were chosen according to what was needed for this new service. Column one entitled OID may comprise a unique object identifier. Column two entitled CallID may comprise an identifier for a specific phone call. Column three entitled CallLength may comprise the length of a specific call. Column four entitled CallDistance denotes the area in miles which the call was placed within. Column five entitled CalledNumber denotes the number the number called. Column six entitled EventDate may comprise the date and time on which the call was placed.

Column seven entitled CustomerID is the identifier to link a call to a specific customer. Column eight entitled RatedCharge is the total charge for the call. For example, row one shows the customer with ID number 000-00-0001, which may be linked to Mrs. Deeley, placed a call within 100 miles of her home on Jan. 22, 1998 at 1:43 pm for a total of 22 minutes. The CustomerCall class and data fields are also represented on screen capture 30.

FIG. 11 illustrates the Bill class table. A customer has one row in the CustomerAccount class, such as row one for Mrs. Deeley. Mrs. Deeley will have more than one bill, for example one every month. For this reason, Mrs. Deeley may have multiple entries in the Bill class table. A new entry or row may be created for each of Mrs. Deeley's bills. As shown in row one, Mrs. Deeley has a bill for Jan. 1, 1998 through Jan. 31, 1998. Mr. Michael, shown in rows two and three, has bills for January and February.

The third column, entitled “Is Customer Group”, denotes a group as opposed to an individual customer. For instance, in row four the Customer ID is “AMS”. The AMS group may consist of multiple customers, for example all the employees of the AMS company. This allows a bill to be calculated for the entire AMS company, consisting of all the AMS employees.

FIG. 12 illustrates the BillPeriod class table. This class defines billing periods. For example, row one contains a billing period named January 1998 with a start date of Jan. 1, 1998 and an ending date of Jan. 31, 1998.

FIG. 13 illustrates the MovieRate class table. FIG. 13 illustrates an example of a class which may be created as needed. Fields are used which define the necessary data which a customer needs to be used in the rental of movies.

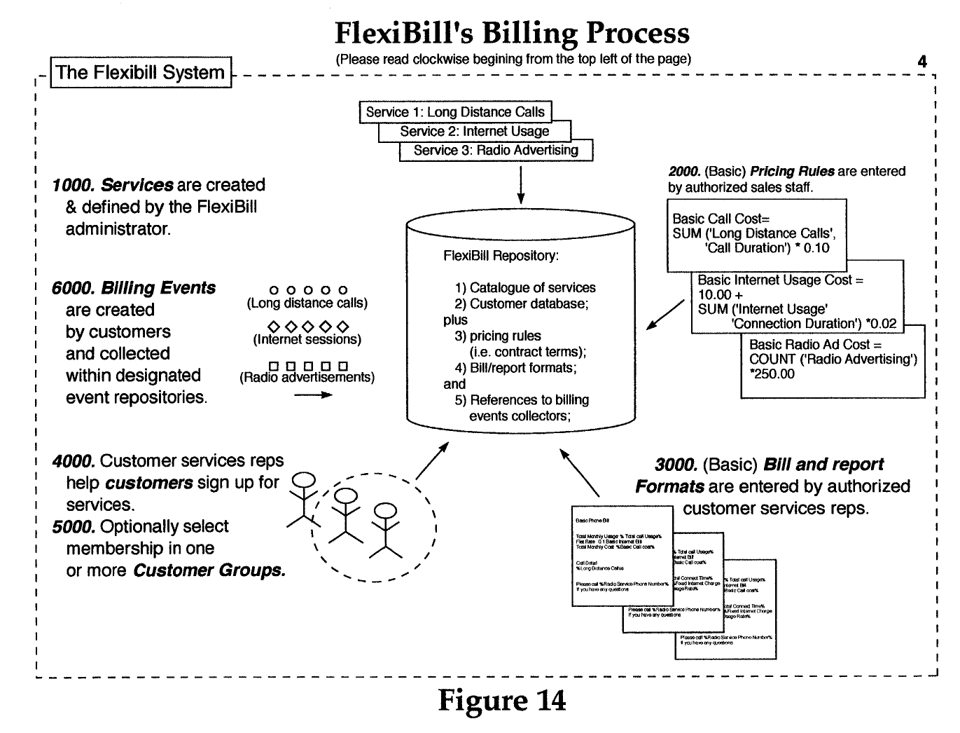

FIGS. 14-20 illustrate a preferred process for implementing billing system 4.

FIG. 14 represents a diagram of billing system 4. Preferably there are six main components of billing system 4: services created 1000, pricing rules 2000, bill and report formats 3000, customer sign up 4000, creation of customer groups 5000, and billing events 6000.

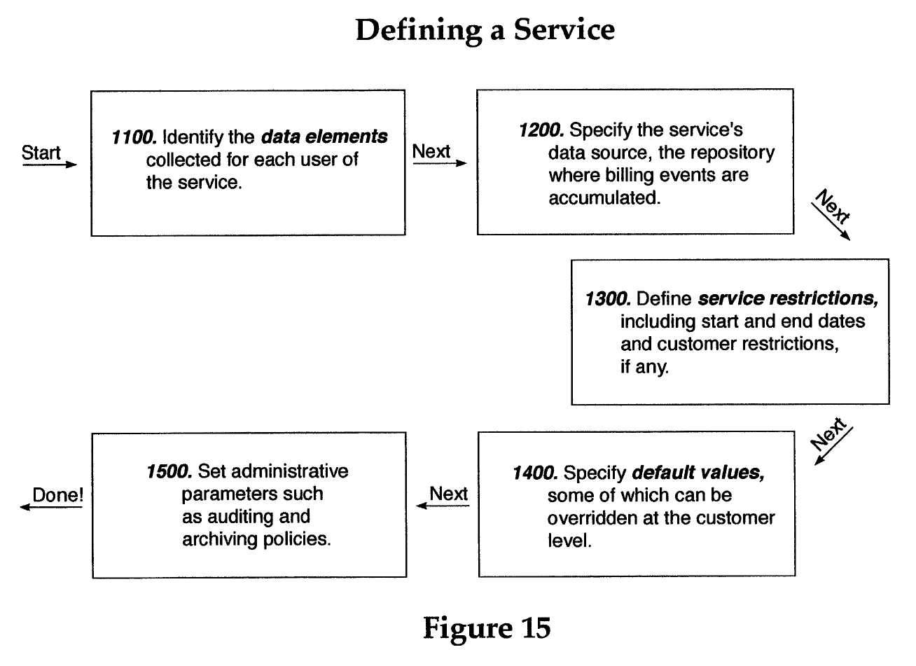

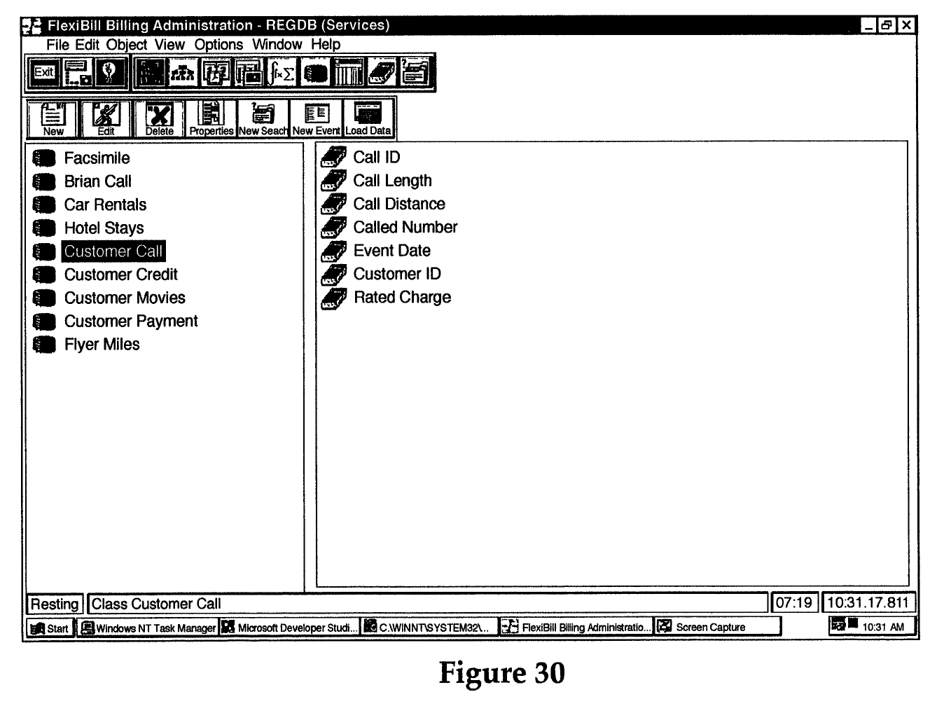

Services created 1000 are defined by the administrator of billing system 4. Services, as shown in FIG. 30 consist of any and all services which require billing. Services created 1000 is described further in FIG. 15.

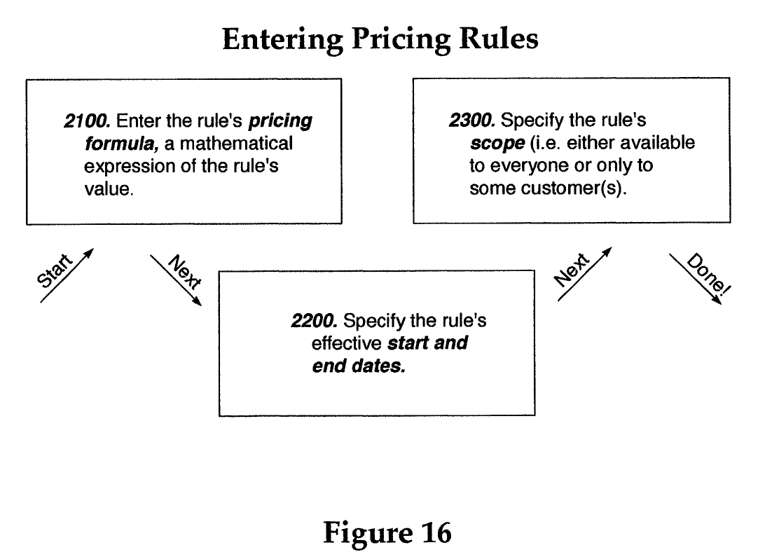

Pricing rules 2000 consist of pricing rules made up of pricing terms. Pricing rules 2000 is described further in FIG. 16.

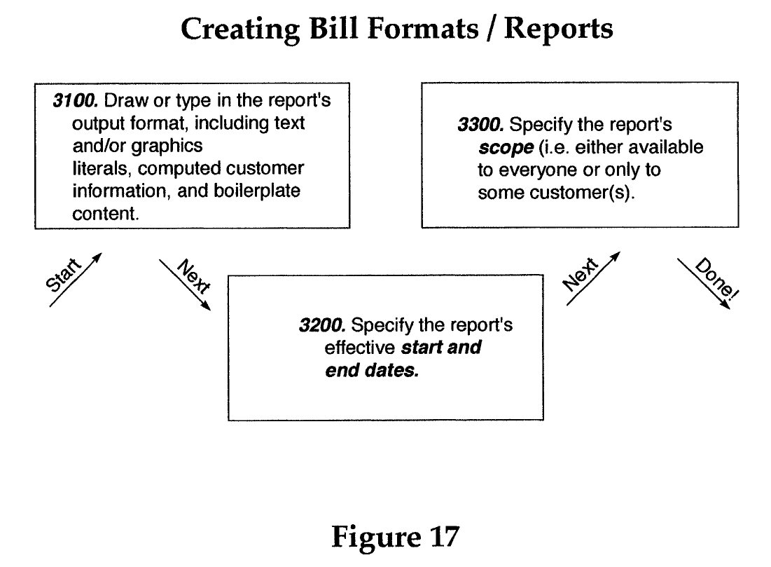

Bill and report formats 3000 consist of the layout of the actual bill given to customers 2. Bill and report formats 3000 is described further in FIG. 17.

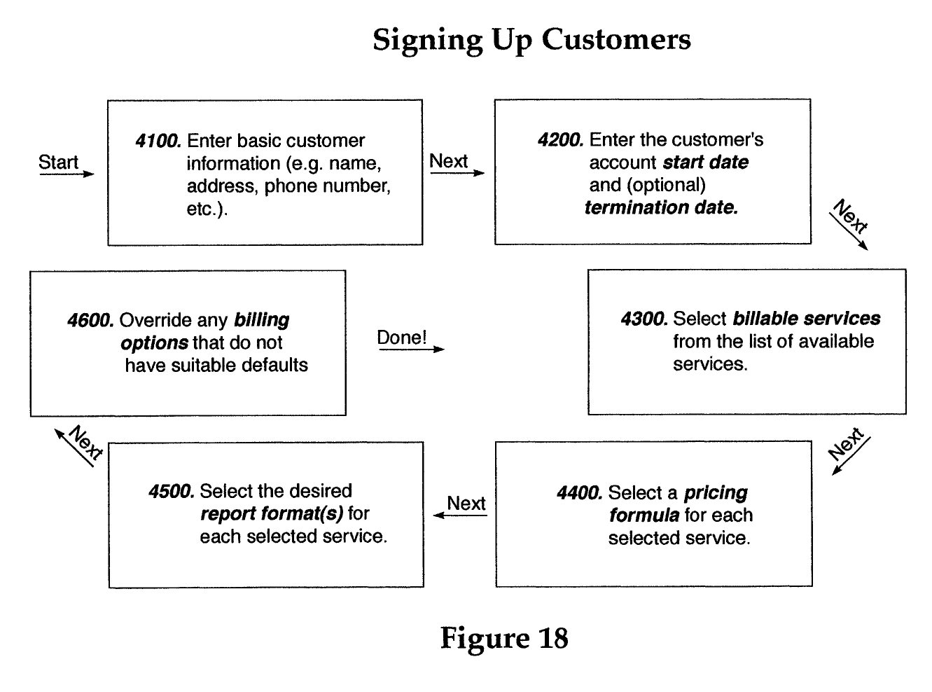

Customer sign up 4000 allows customers 2 to sign up for any services, as shown in FIG. 30. Customer sign up 4000 is described further in FIG. 18.

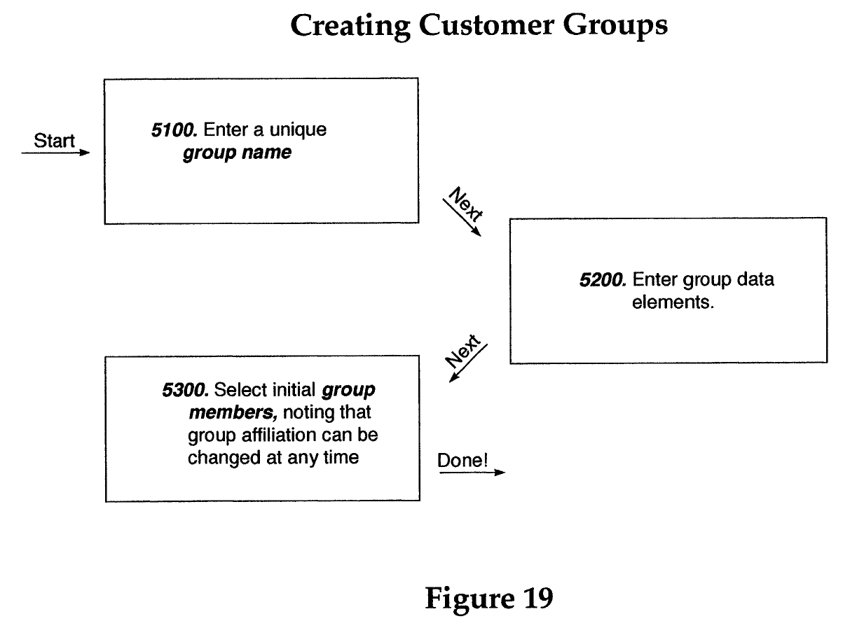

Creation of customer groups 5000 allows new groups to be created by the administrator of the billing system 4. Creation of customer groups 5000 is described further in FIG. 19.

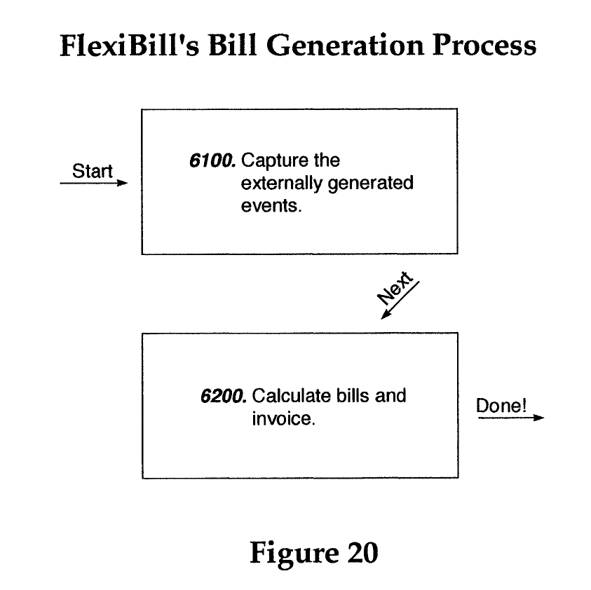

Billing events 6000 allows for the actual billing. Billing events 6000 is described further in FIG. 20.

All six billing system 4 components may be modified dynamically at any time by the billing system administrator 6.

FIG. 15 describes services created 1000 of FIG. 14 in further detail. Services created 1000 is an administrative action to be performed by system administrator 6 and not customer service representative 8. Services created 1000 are defined by starting with step 1100 to identify the data elements which will be collected for each customer 2. For example, the service “CustomerCall” is shown in the “CustomerCall” class in FIG. 10. Screen capture 30 shows the creation of the “CustomerCall” class. The data elements used in defining the “CustomerCall” class are defined in the “ClassDefs” table shown in FIG. 3, and stored in the “CustomerCall” class in FIG. 10. The class definition, defining which data elements are contained in the class and the elements sequence are stored in the ClassComp table shown in FIG. 4.

Next, step 1200 is to specify the services data source 10. System administrator 6 will specify the repository where the data is accumulated and how to connect to it. Preferably the repository is a relational database. The repository may be, and is not limited to, a flat file or a database such as Oracle, relational, object oriented, containing the data. The data source 10 may also be accessed through pointers pointing to the data. Step 1300 defines service restrictions for data integrity reasons. For example, a telephone call of customer 2 must be greater than 0 minutes. The field “CallLength” as stored in “CustomerCall” table shown in FIG. 10 has the constraint shown in the “ClassConstraints” table in FIG. 7, row four. Next, step 1400 allows default values to be overridden by system administrator 6. For example, the default billing period may be to bill monthly as stored in the BillPeriod Class in FIG. 12 rows one and two. Customers 2 associated with each billing period are shown in screen capture 26. System administrator 6 could override the monthly billing period and create a bi-monthly billing period as stored in the BillPeriod Class in FIG. 12 rows three and four. Billing 20 periods and other customer 2 billing options are stored in FIG. 11.

Step 1500 allows system administrator 6 to set parameters such as auditing and archiving policies. Auditing consists of running reports. Archiving paramaters such as time of archive, frequency, and other archiving paramaters may be set.

FIG. 16 describes pricing rules 2000 of FIG. 14 in further detail. Pricing rules 2000 begins with step 2100 allowing the billing system administrator 6 and customer service representative 8 to enter the pricing rules formula. An example of pricing rule formulas is shown in FIG. 6, the BusinessRules table, and on screen capture 29. Next, step 2200 allows the billing system administrator 6 to specify the start and end dates for each pricing rule formula. Step 2300 then allows the billing system administrator 6 to specify the scope. For example, the pricing rule formula for a credit card billing event may be a 5.9% APR for one month and a 16% APR after the first month. In the credit card example the pricing rule formula would have the name, such as CustCredit, and a scope of 5.9% APR for one month and 16% APR thereafter. The CustCredit pricing rule is stored in the BusinessRules table shown in FIG. 6.

FIG. 17 describes the creation of bill and report formats 3000 of FIG. 14 in further detail. Through the use of a graphical tool such as a GUI (Graphical User Interface) text and graphics may be manipulated on screen to format bills and reports. Bills may be tailored to the needs of customer 2. This process begins with step 3100 which allows a system administrator 6, or customer service representative 8, of the billing system 4 to define bill formats and report output format. Step 3200 then allows an effective start and end date to be defined for the bill or report. Step 3300 allows the scope of the report or bills to be defined to certain groups.

A sample bill format is shown on screen capture 27, labeled as the bill format text, and stored in the BusinessRules table shown in FIG. 6 as DefaultBillFormat.

A GUI interface is shown in screen capture 28. This bill painter allows each individual customer to have a unique bill. The GUI allows any and all data elements to be placed anywhere on the face of the bill according to customer wishes. Colors, fonts, and other graphical elements are completely customizable. A sample bill painter format is shown on screen capture 28, the format shown is highlighted as “Brian Bill Format 1”.

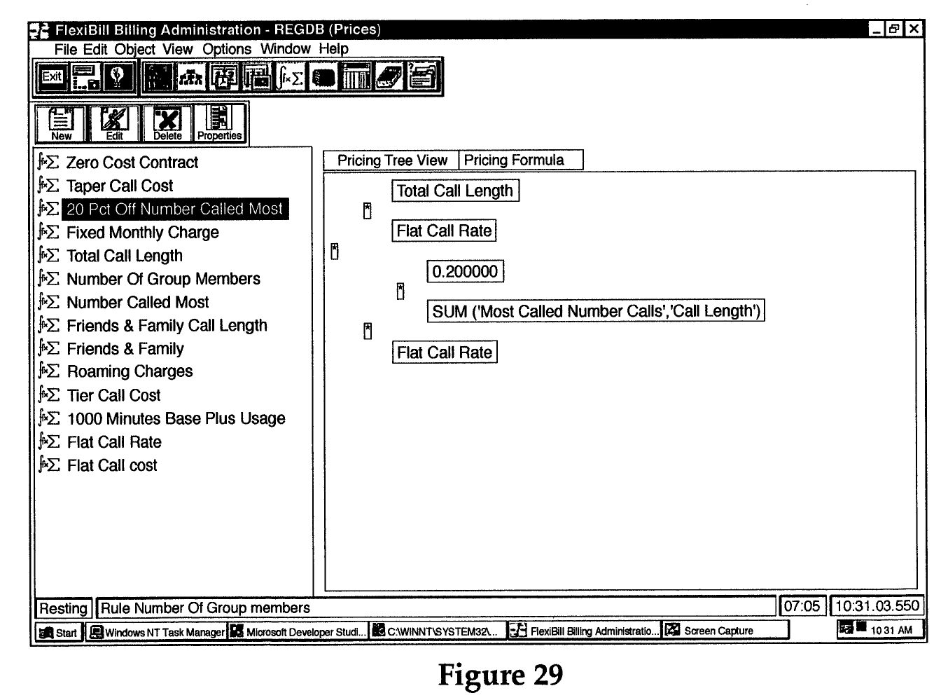

The bill painter may also walk through the calculation for each field shown on the bill. This feature allows a customer to determine how each field was calculated. A sample screen capture showing how the “twenty percent off number called most” filed is calculated is shown in FIG. 29.

Queries, for reporting purposes, may be run at any time. Queries are stored in the SavedQueries table shown in FIG. 5.

FIG. 18 describes the customer sign up 4000 of FIG. 14 in further detail. Screen captures shown in FIGS. 22, 23, 24 depict the customer service representative 8 GUI for entering customer data for customer sign up 4000. This process begins with step 4100 allows the billing system administrator 6, or a customer service representative 8, to enter basic customer information stored in the table shown on FIG. 9, and in screen capture 22. Step 4200 defines a customer 2 start date and optional termination date, termination date field would be added to CustomerAccount class in FIG. 9. Additional customer 2 information is stored in the CustomerAccount class in FIG. 9 and shown in screen capture 23. Step 4300 allows services to be assigned to a particular customer 2. Step 4400 selects a pricing plan to be associated with the service of a particular customer 2. Customer 2 may have a different pricing plan created for each service. Step 4500 then allows the desired report format to be selected for each selected service. Customers 2 may also have membership in more than one group. Then, step 4600 allows billing options which do not have suitable defaults to be overridden. Screen capture 24 shows the customer associated with the highlighted CustomerID 000-00-0001.

FIG. 19 describes the creation of customer groups 5000 of FIG. 14 in further detail. Screen capture 25 represents the highlighted group AMS-Telecom stored in the CustomerAccount class shown in FIG. 9, row four. Row four, column 14, entitled “Is Customer Group” is shown set to true denoting this as a customer which is also a group. By being a group, this customer may have other customers as group members.

This process begins with step 5100 allowing the billing system administrator 6, or customer service representative 8, to enter a new and unique group name. Next, step 5200 allows for the entering of the customer account information needed for the CustomerAccount class shown in FIG. 9. Step 5300 allows the customer to have group members. For example, in row three column eleven the field “Parent Customer Name” is AMS-Telecom denoting David Lee is a member of the AMS-Telecom group. Group members may be changed at any time in the future.

FIG. 20 describes the billing events 6000 of FIG. 14 in further detail. Step 6100 captures the externally generated events. For example, an event may be a customer 2 placing a telephone call and hanging up. When customer 2 hangs up the phone a computer records information about the call and generates a record of the call, which represents an event. For the example of telephone calls, these events would be taken from the external source which logs the calls and stored in the CustomerCall class shown in FIG. 10. Once these events are captured step 6200 calculates the bills and invoices the appropriate customers.

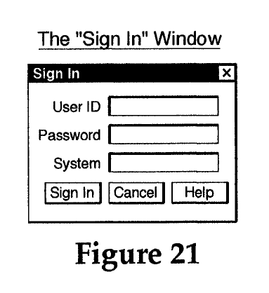

FIG. 21 displays an illustrative screen capture of the billing system 4 sign in window.

FIGS. 22, 23, and 24 display screen captures depicting the customer service representative 8 GUI for customer sign up 4000. Customer IDs are located on the left hand side of the divider in 22, 23, and 24.

FIG. 22 shows a screen capture having the name and address, on the right side of the divider, which corresponds to Customer ID 000-00-0001 on the left side of the divider. Under the title “Primary Customer Contact Information” are the data elements which make up the customer name and address from the CustomerAccount class represented in a table in FIG. 9. As shown, Customer ID 111-11-111 corresponds to customer Donna Deeley.

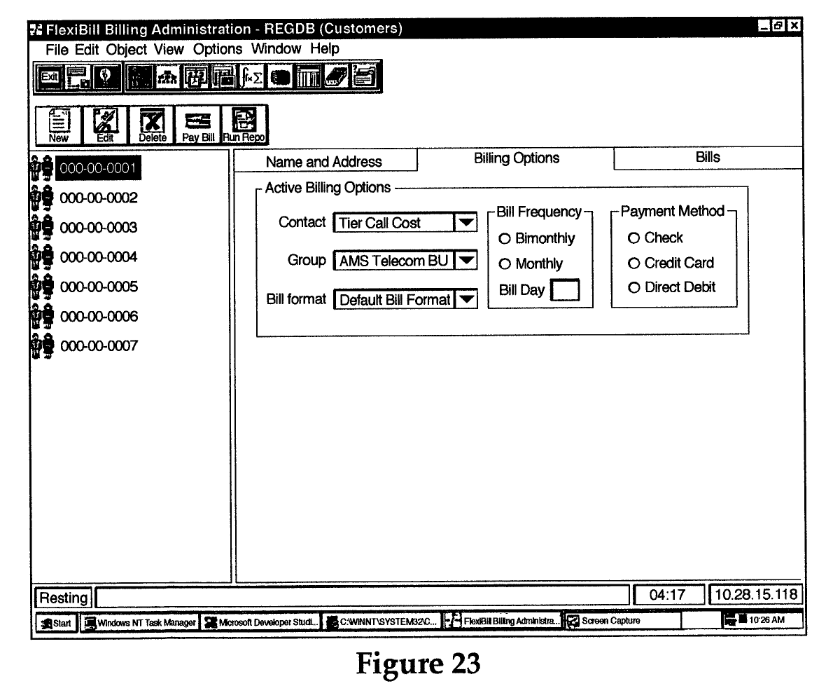

FIG. 23 shows a screen capture, under the title “Billing Options”, with data elements stored in the CustomerAccount in FIG. 9.

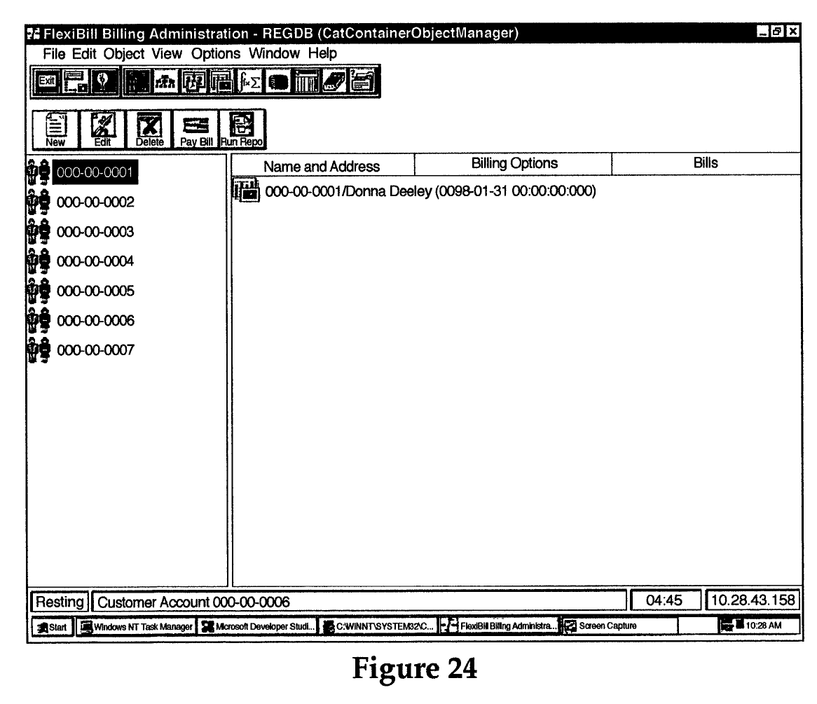

FIG. 24 shows a screen capture, under the title “Bills”, containing bills associated with the highlighted Customer ID. The highlighted CustomerID is 000-00-0001 which is associated with Donna Deeley. Mrs. Deeley is shown to have one bill for January 1998. This data is represented in FIG. 11 row one.

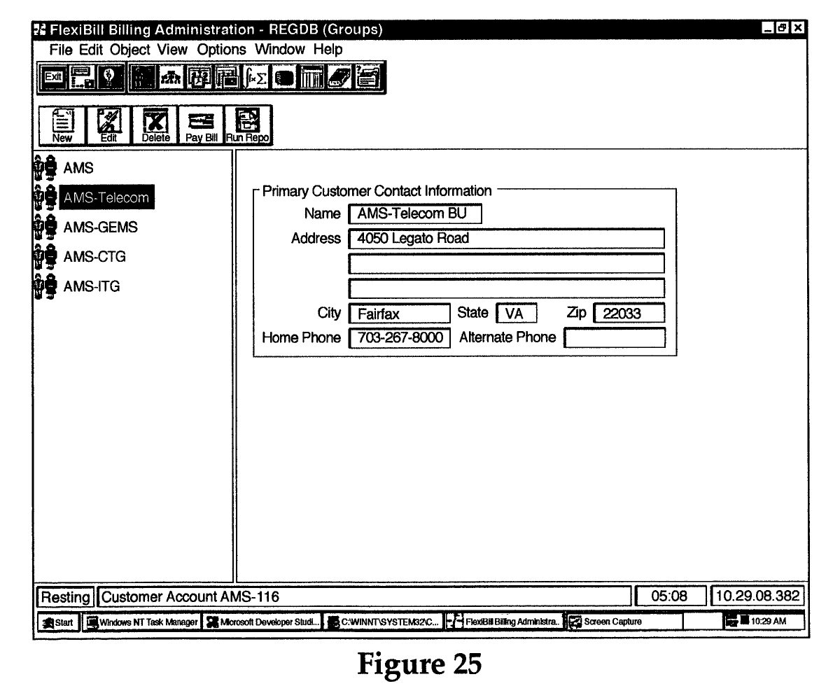

FIG. 25 displays a screen capture representing the highlighted group AMS-Telecom stored in the CustomerAccount class shown in FIG. 9, row four. Row four, column 14, entitled “Is Customer Group” is shown set to true denoting this as a customer which is also a group.

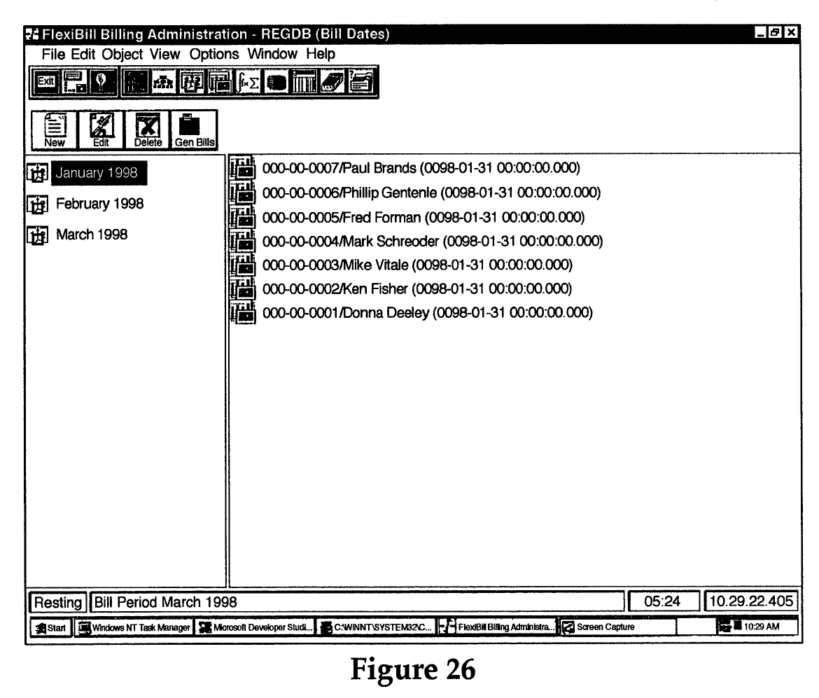

FIG. 26 displays a screen capture depicting the various billing periods. The highlighted billing period is January 1998 and represents a billing run, the bills on the right are created when the “January” billing run is completed.

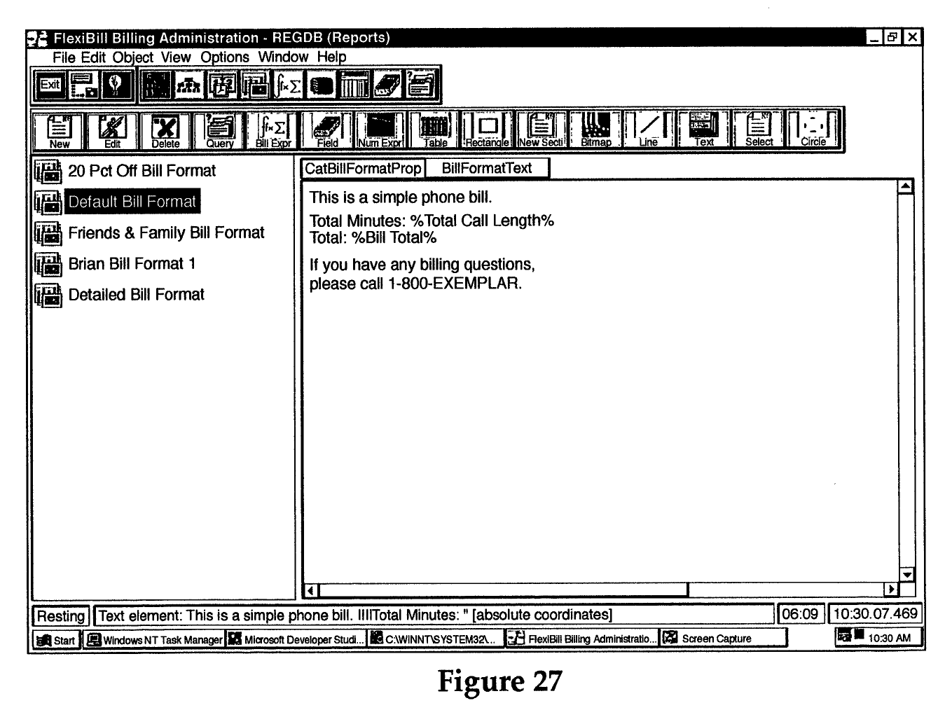

FIG. 27 displays a screen capture depicting a representative bill format. On the left of the divider bar is the Bill Format Name “DefaultBillFormat”, as stored in the BusinessRules table FIG. 6, row five. On the right side of the divider bar is the Bill Format Text. A new bill format may be created by a system administrator 6, or a customer service representative 8, using the GUI shown.

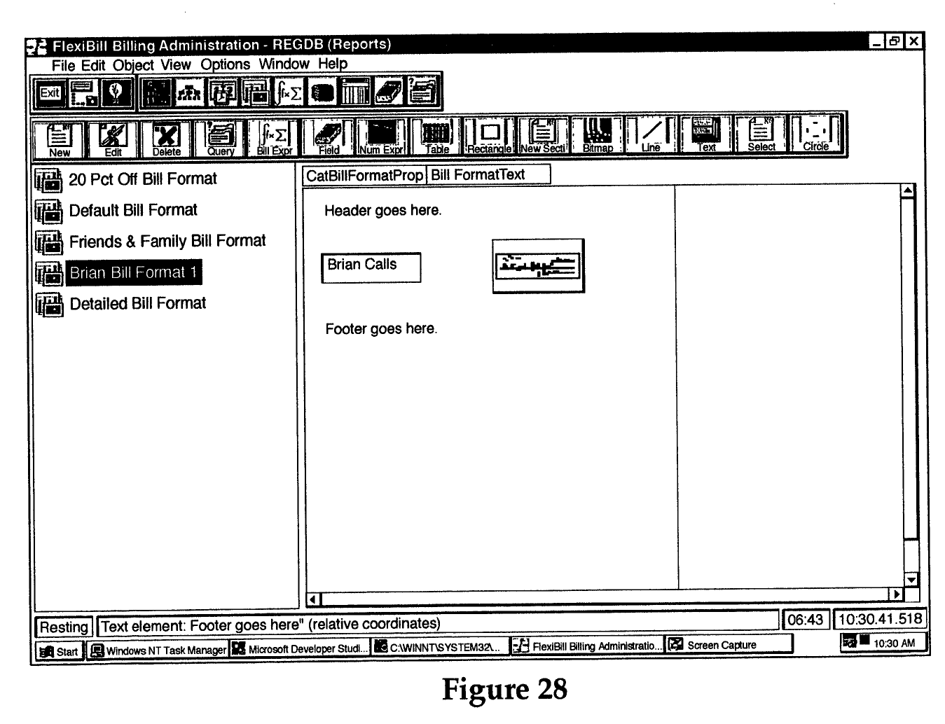

FIG. 28 displays a screen capture depicting the Bill Painter. Bill Painter is a GUI interface which allows each customer 2 to have a unique bill to fit their needs.

FIG. 29 displays a screen capture depicting the step by step display of the calculation for the pricing formula “20 Pct Off Number Called Most”. This feature allows a step by step explanation of how fields are calculated. On the right side of the divider is the pricing rule formula corresponding to the highlighted rule name on the left side of the divider. Screen capture 26 corresponds to the data elements in the BusinessRules table shown in FIG. 6.

FIG. 30 displays a screen capture depicting the Available services, stored as classes, are shown on the left side of the divider. Data elements contained in the highlighted class are shown on the right side of the divider. This screen capture represents the data fields in the CustomerCall class shown in FIG. 10.

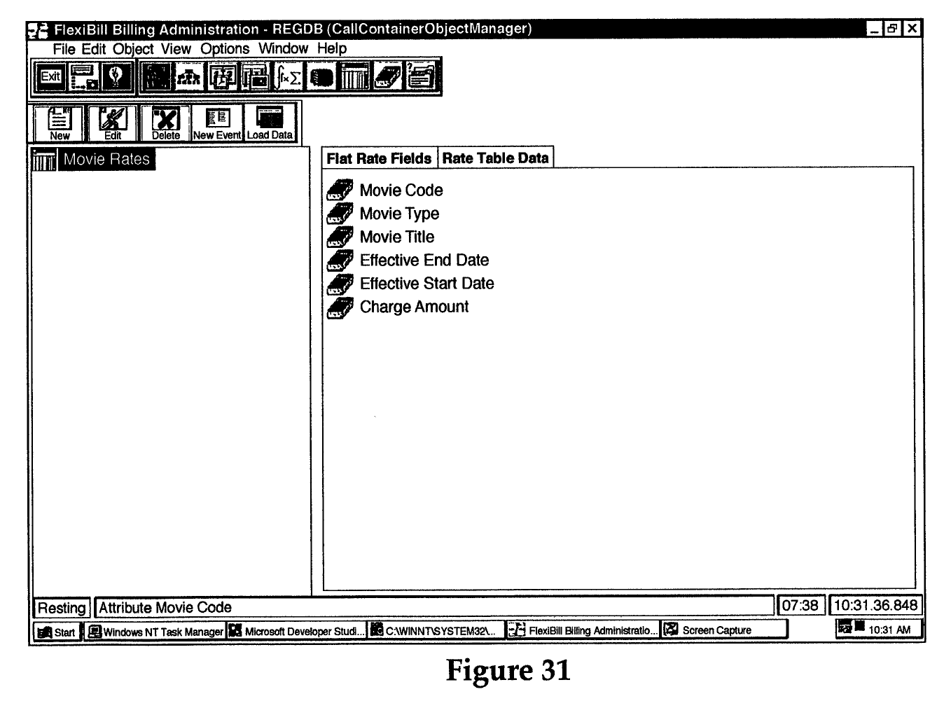

FIG. 31 displays a screen capture depicting an example of a class which may be created at any time to meet the needs of a customer. In this screen capture a Movie Rate class is created for the rental of movies. FIG. 13 shows how the data is stored.

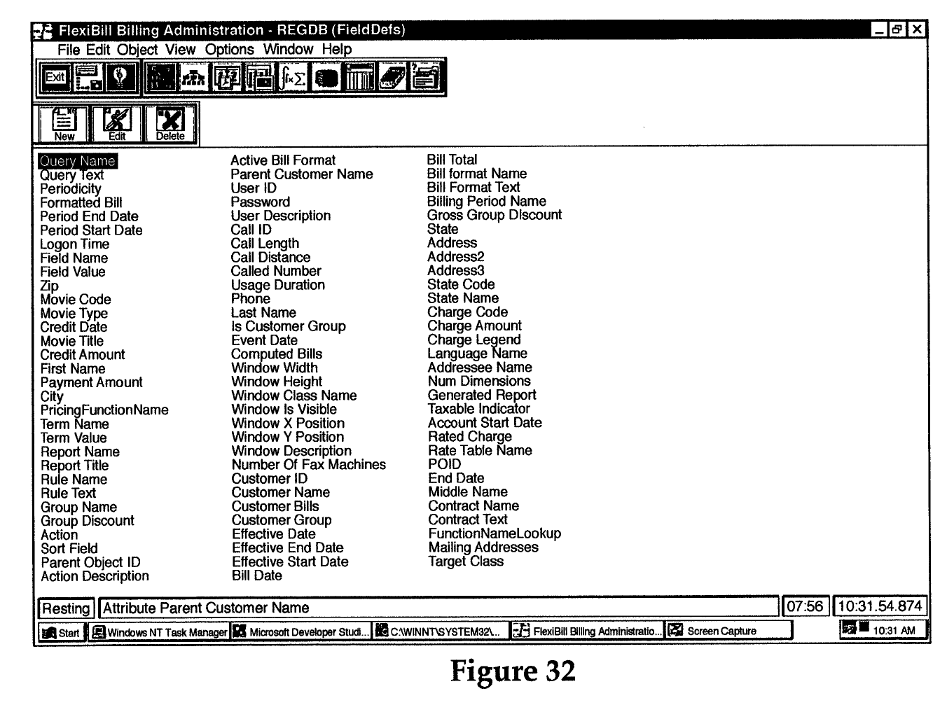

FIG. 32 displays a screen capture depicting field definitions which make up the data dictionary. FIG. 32 illustrates a list of all possible variables and/or fields.

FIG. 33 displays a screen capture depicting queries. Query names are located on the left of the divider while the query corresponding to the highlighted query is on the right of the divider bar. Screen capture 33 corresponds to the data elements in the SavedQueries table shown in FIG. 5.

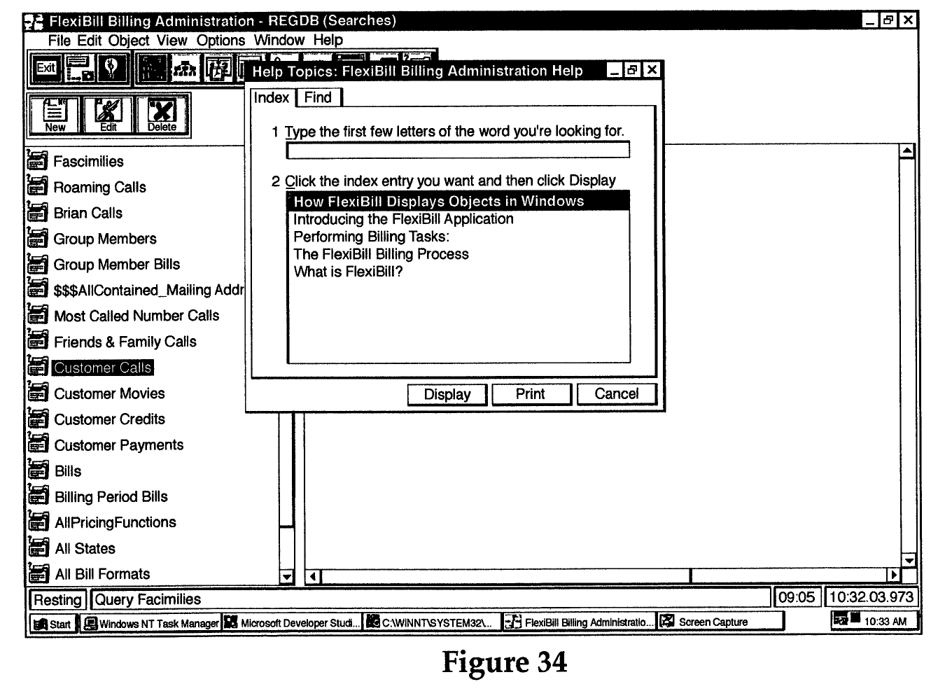

FIG. 34 displays a screen capture depicting a help window displaying help topics.

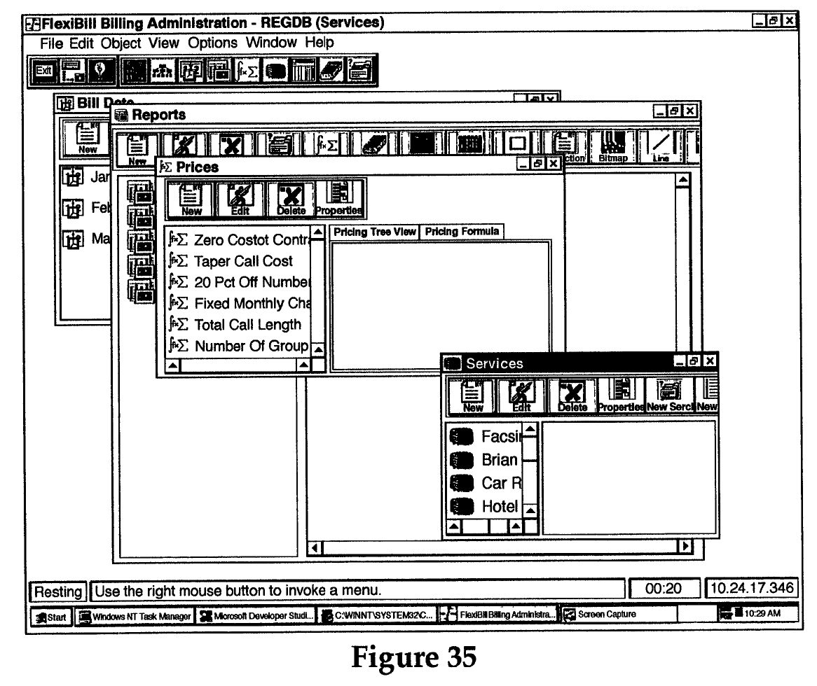

FIG. 35 displays a screen capture showing multiple windows may be displayed simultaneously for more efficient use of the billing system 4.

Although disclosed in the context of a billing environment, the present invention may be applied to other uses as well. For example, the technology of the present invention may be used for non-billing services such as customer service, e-commerce, back office data integration, and the like.

Further, both the pricing rules and billing formats disclosed herein are examples of, but not the only examples of, what are called business rules. The pricing rules and billing formats illustrated herein are shown by way of example only and should not be construed as limiting the present invention in any way. Pricing rules and billing formats may be stored externally from the rest of system data, to insure that business logic, as expressed in these business rules, cannot become inappropriately intertwined with the core logic, to insure the system maintains flexibility.

While the preferred embodiment and various alternative embodiments of the invention have been disclosed and described in detail herein, it may be apparent to those skilled in the art that various changes in form and detail may be made therein without departing from the spirit and scope thereof.

I claim: What is claimed is

1. A data processing system for billing customers, the system comprising:
a service creating module consisting of a set of data processing instructions to prompt a user for service type and corresponding data elements;
a data retrieving module for retrieving billing events from data storage;
a pricing rules creation module for creating pricing rules consisting of a graphical user interface to prompt a user to manipulate data elements and create a pricing rule;
a customer association module to associate a customer with a service consisting of a set of data processing instructions to prompt a user for a service to be associated with a customer;
a pricing association module to associate a pricing rule to each customer consisting of a set of data processing instructions to prompt a user for a pricing rule to be associated with a customer;
a invoice creating module for creating customer's invoices, and
a invoice sending module for sending customer's invoices.

2. A data convergence system for processing data from a plurality of data sources having at least some of having different corresponding predetermined data formats, the data convergence system comprising:
a plurality of data harvesting software modules, each for retrieving data from a corresponding one the plurality of data sources at least some of having different corresponding predetermined data formats and converting the data while being retrieved to a common predetermined data format to produce converted data in the predetermined data format, and
a software system coupled to the plurality of data harvesting modules, for processing the converted data in a predetermined common format to produce processed data.

3. The data convergence system of claim 2, wherein the plurality of data sources having at least some of having different corresponding predetermined data formats comprise a plurality of billing source databases.

4. The data convergence system of claim 3, wherein the software system comprises a billing software system for generating a bill for data from one or more the billing source databases.
